(19) United States
(12) Patent Application Publication
(10) Pub. No.: US 2014/0215515 A1
(43) Pub. Date: Jul. 31, 2014

(54) TELEVISION RECEIVER, PORTABLE INFORMATION TERMINAL AND INFORMATION EXCHANGE SYSTEM INCLUDING SAME

(71) Applicants: Tomohiko Toyonaga, Moriguchi-shi (JP); Takaya Nonomura, Moriguchi-shi (JP); Ippei Kiyama, Moriguchi-shi (JP)

(72) Inventors: Tomohiko Toyonaga, Moriguchi-shi (JP); Takaya Nonomura, Moriguchi-shi (JP); Ippei Kiyama, Moriguchi-shi (JP)

(73) Assignee: SANYO ELECTRIC CO., LTD., Moriguchi-shi, Osaka (JP)

(21) Appl. No.: 14/239,397

(22) PCT Filed: Jul. 5, 2012
(86) PCT No.: PCT/JP2012/067217

§ 371 Date: Feb. 18, 2014

(30) Foreign Application Priority Data
Sep. 28, 2011 (JP) 2011-212714

(51) Int. Cl. H04N 21/422; H04N 21/41

(52) U.S. Cl. CPC H04N 21/42209; H04N 21/4126
USPC 725/39

(57) ABSTRACT

An information exchange system is provided in which users passing each other can realistically exchange opinions on a television program. Hence, the information exchange system includes a television receiver and a portable information terminal which performs short-range communication with the television receiver and another portable information tenuinal, where the television receiver acquires, from a broadcast wave, program information including an identifier and a program name of a specified program, and transmits the program information to the portable information terminal within a range of the short-range communication, and the portable information terminal acquires the program information from the television receiver, associates a comment with the acquired program information to receive an input of the comment and exchanges the comment with another portable information terminal which comes into the range of the short-range communication.

### TECHNICAL FIELD

The present invention relates to a television receiver, a portable information terminal and an information exchange system including the television receiver and the portable information terminal.

### BACKGROUND ART

In order to connect to a network to exchange or download data, it has previously been necessary to receive an instruction from a user. However, in recent years, a technology called “passing-each-other communication” has been proposed in which even in conditions where it is impossible to perform constant connection due to an environment in which distances to access points are not constant, an attempt to automatically connect to an access point when necessary is made to realize a connection state similar to constant connection (see patent document 1).

Thus, it is possible to connect to an access point when necessary without an instruction from the user and thereby perform predetermined data communication processing. This technology has been installed into portable game machines as a “passing-each-other communication function.”

Incidentally, when you want to exchange thoughts and opinions with a large number of members or strangers on a television program that has been viewed or a television program that is viewed every week, it is common to post a message onto a community on the Internet.

### RELATED ART DOCUMENT

### Patent Document

Patent document 1: Japanese Patent No. 4676033

### SUMMARY OF THE INVENTION

### Problems to be Solved by the Invention

However, when a community is utilized, not only information desired by the user but also useless information or unpleasant information for the user may be included. Moreover, since the messages of other people are updated even when the user posts no thoughts and opinions onto a community, the user is unlikely to have a feeling of participation. Hence, a community cannot be utilized effectively, and thus useful information cannot be exchanged.

On the other hand, in the passing-each-other communication described above, it is possible to exchange information with other users without intervention of a community, it is likely to be used as a new communication means.

An object of the present invention is to provide an information exchange system in which users passing each other can realistically exchange opinions on a television program. Another object is to provide a television receiver and a portable information terminal that realize such a system.

### Means for Solving the Problem

According to the present invention, there is provided an information exchange system that includes a television receiver and a portable information terminal which performs short-range communication with the television receiver and another portable information terminal, where the television receiver acquires, from a broadcast wave, program information including an identifier and a program name of a specified program, and transmits the program information to the portable information terminal within a range of the short-range communication, and the portable information terminal acquires the program information from the television receiver, associates a comment with the acquired program information to receive an input of the comment and exchanges the comment with another portable information terminal which comes into the range of the short-range communication.

Preferably, in the information exchange system described above, the portable information terminal compares the identifiers with the another portable information terminal which comes into the range of the short-range communication, and exchanges a comment which is associated with the same identifier.

Preferably, in the information exchange system described above, the comment includes an opinion and an evaluation of a user, the portable information terminal collects the evaluations and the portable information terminal or the television receiver displays a collection result of the evaluations.

Preferably, in the information exchange system described above, the portable information terminal can set a condition under which the short-range communication is performed with the another portable information terminal.

Preferably, in the information exchange system described above, the condition under which the short-range communication is performed includes profile information on the user.

Preferably, in the information exchange system described above, the portable information terminal includes a present location acquisition portion that acquires positional information on a present location, acquires a place where the comment is exchanged with the another portable information terminal and associates the place with the exchanged comment.

Preferably, in the information exchange system described above, when the comment is exchanged, the portable information terminal notifies information that the comment is exchanged.

According to the present invention, there is provided a television receiver that performs short-range communication with a portable information terminal, where the television receiver acquires, from a broadcast wave, program information including an identifier and a program name of a specified program, and transmits the program information to the portable information terminal within a range of the short-range communication.

Preferably, in the television receiver described above, the television receiver acquires a comment associated with the program information from the portable information terminal, and displays the comment.

According to the present invention, there is provided a portable information terminal that performs short-range communication with a television receiver or another portable information terminal, where the portable information terminal acquires program information including an identifier and a program name of a program from the television receiver, associates a comment with the acquired program information to receive an input of the comment and exchanges the comment with another portable information terminal which comes into a range of the short-range communication.

Preferably, in the portable information terminal described above, the portable information terminal compares the identifiers with the another portable information terminal which comes into the range of the short-range communication, and exchanges a comment which is associated with the same identifier.

Preferably, in the portable information terminal described above, the comment includes an opinion and an evaluation of a user, the portable information terminal collects the evaluations and displays a collection result of the evaluations.

Preferably, in the portable information terminal described above, the portable information terminal can set a condition under which the short-range communication is performed with the another portable information terminal.

Preferably, in the portable information terminal described above, the condition under which the short-range communication is performed includes profile information on the user.

Preferably, in the portable information terminal described above, the portable information terminal includes a present location acquisition portion that acquires positional information on a present location, acquires a place where the comment is exchanged with the another portable information terminal and associates the place with the exchanged comment.

Preferably, in the portable information terminal described above, when the comment is exchanged, the portable information terminal notifies information that the comment is exchanged.

### EFFECTS OF THE INVENTION

According to the present invention, wherever a user acts, it is possible to provide an environment in which information exchange on a program can be performed. Hence, since users who pass each other and do not know each other can immediately and directly exchange opinions in a town, a public place, a street along which to commute every day, an often-visited restaurant or the like, it is possible to realize, even in a usual place, realistic communication that has not been experienced and that induces the user to go to town.

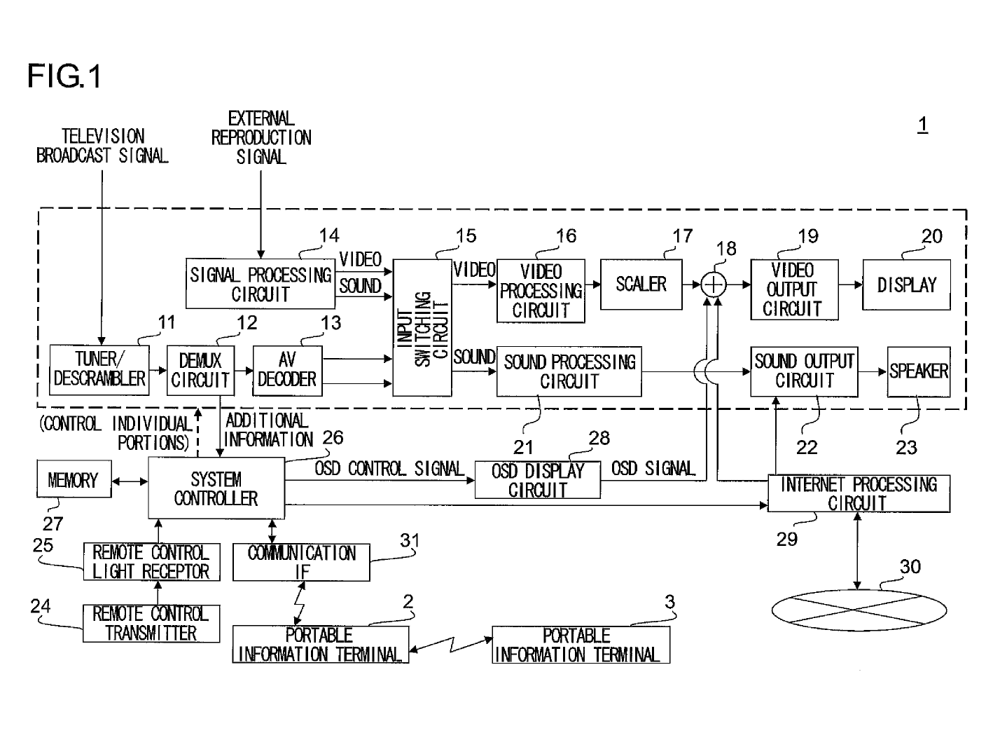

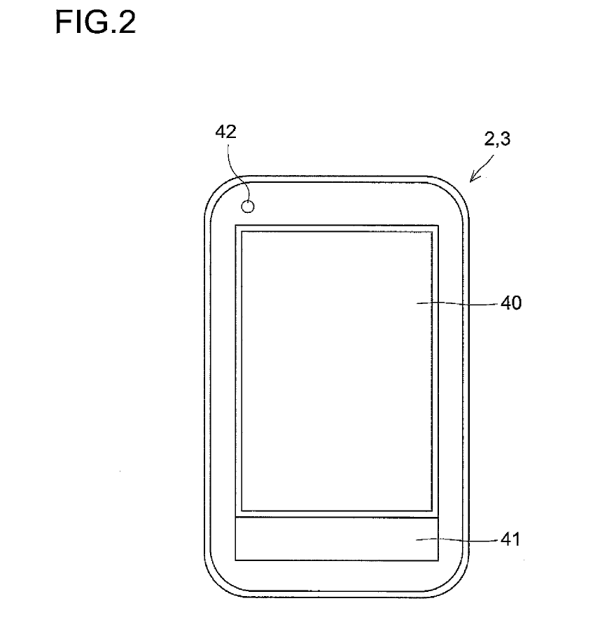

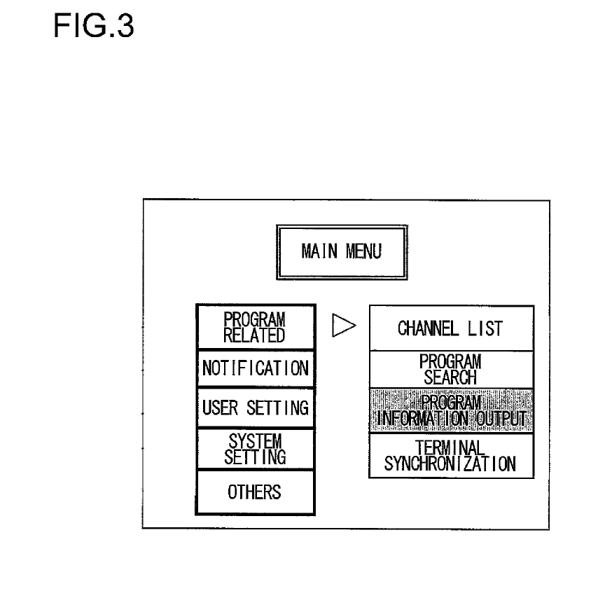

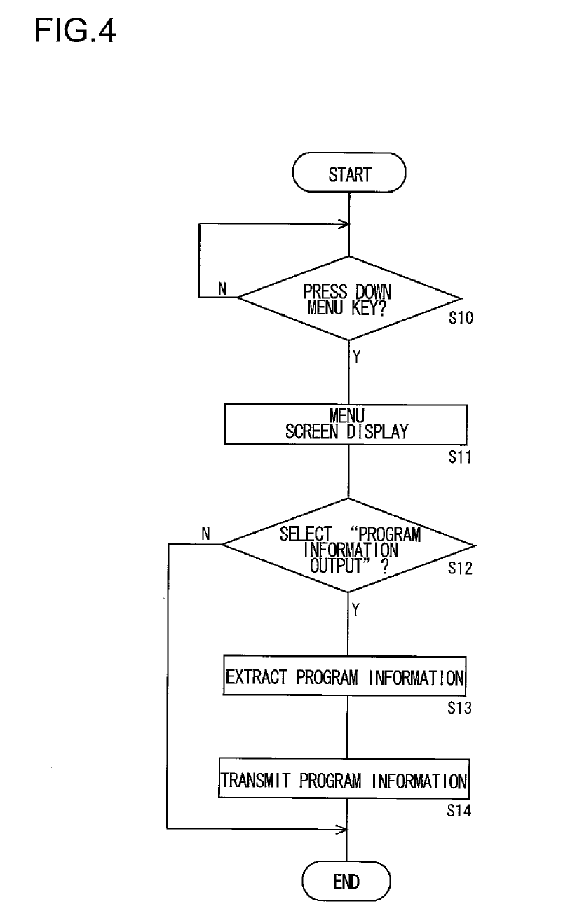

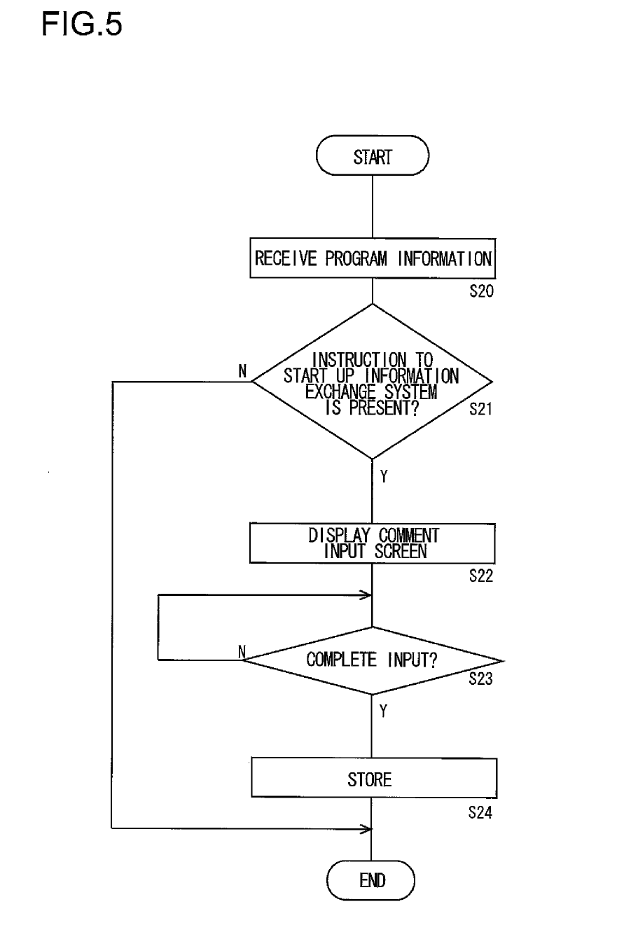

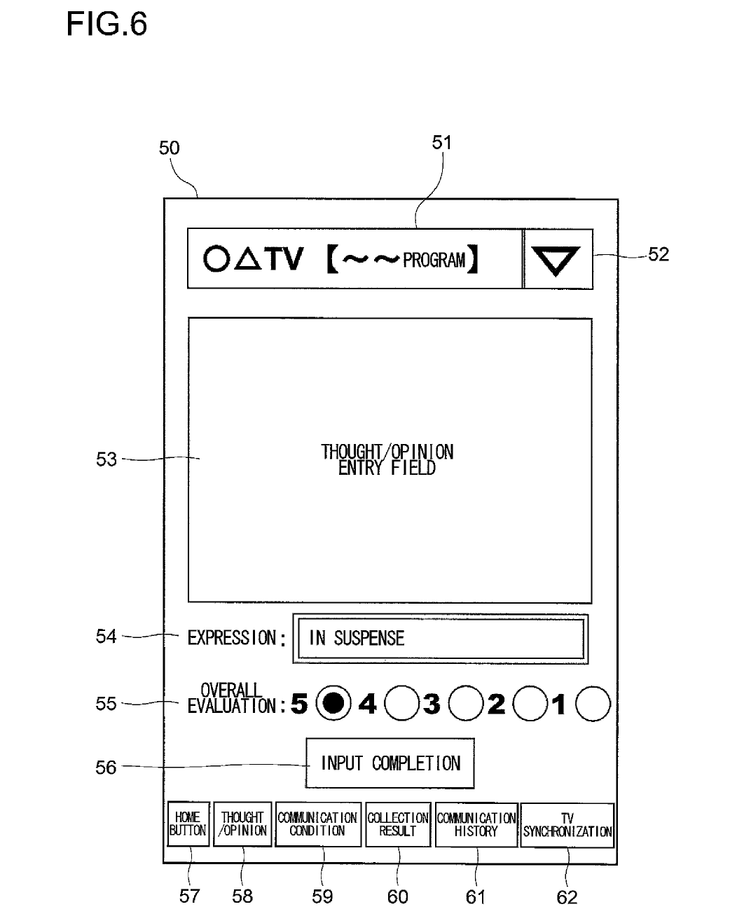

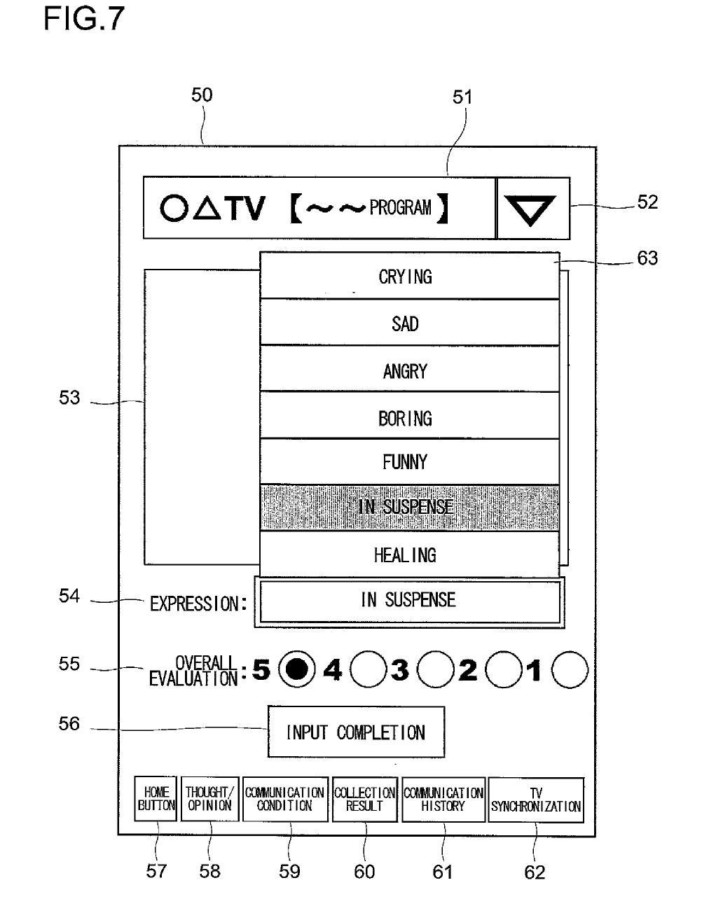

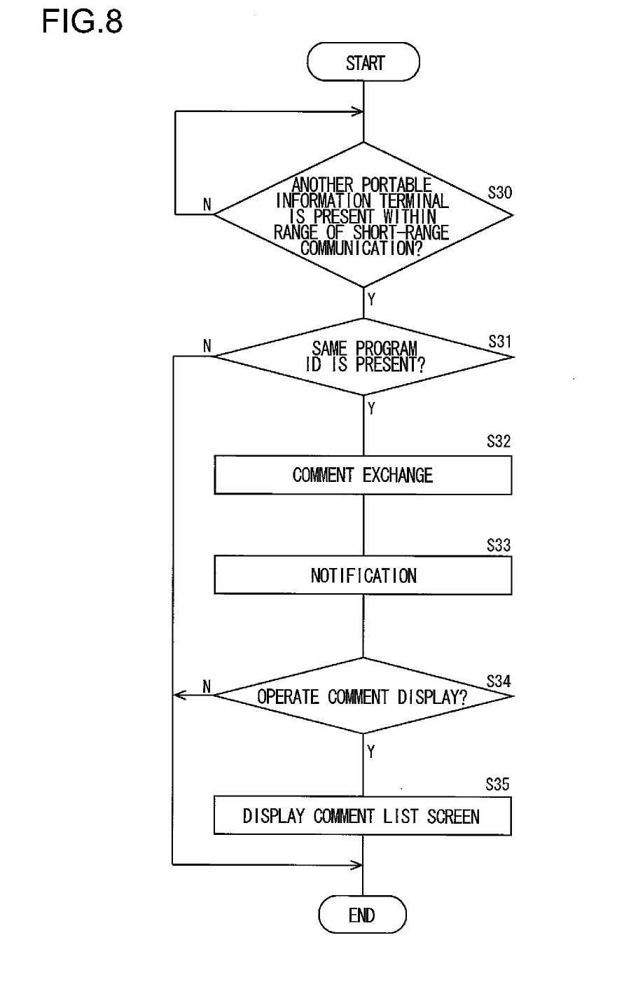

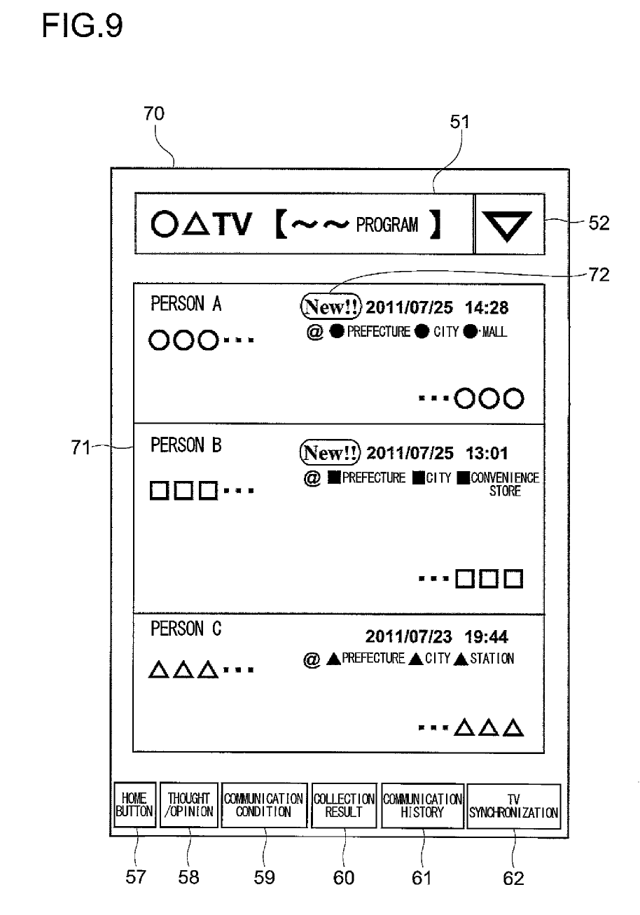

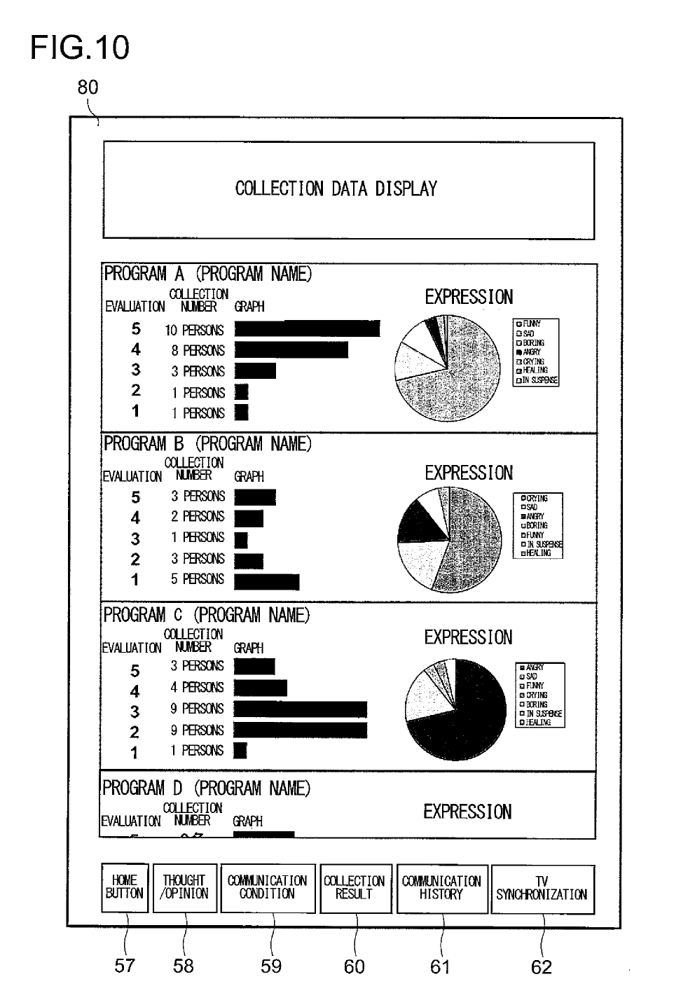

### BRIEF DESCRIPTION OF DRAWINGS

[FIG. 1] A block diagram of an information exchange system according to an embodiment of the present embodiment;

[FIG. 2] A plan view of a portable information terminal according to the embodiment of the present invention;

[FIG. 3] A diagram showing an example of a menu screen;

[FIG. 4] A flowchart showing an operation of a television receiver on information exchange;

[FIG. 5] A flowchart showing an operation of the portable information terminal on the information exchange;

[FIG. 6] A diagram showing an example of a comment input screen;

[FIG. 7] A diagram in which a popup screen is superimposed and displayed on the comment input screen of FIG. 6;

[FIG. 8] A flowchart showing an operation between the portable information terminals on the information exchange;

[FIG. 9] A diagram showing an example of a list screen of comments on a program whose information is exchanged; and

[FIG. 10] A diagram showing an example of a collection result screen.

### DESCRIPTION OF EMBODIMENTS

An embodiment of the present invention will be described below with reference to accompanying drawings.

FIG. 1 is a block diagram of an information exchange system according to the embodiment of the present embodiment. The information exchange system includes a television receiver 1 and portable information terminals 2 and 3.

The television receiver 1 includes a tuner/descrambler 11, a DEMUX circuit 12, an AV decoder 13, a signal processing circuit 14, an input switching circuit 15, a video processing circuit 16, a scaler 17, a combination circuit 18, a video output circuit 19, a display 20, a sound processing circuit 21, a sound output circuit 22, a speaker 23, a remote control transmitter 24, a remote control light receptor 25, a system controller 26, a memory 27, an OSD display circuit 28, an Internet processing circuit 29 and a communication IF (interface) 31.

An antenna or the like is connected to the television receiver 1; signals for a plurality of types of television broadcast (for example, CS/BS digital broadcast, terrestrial digital broadcast and CATV) are transmitted. Moreover, a content external reproduction machine (for example, a DVD player) is connected to the television receiver 1′; external reproduction (external input) signals output from the external reproduction machine are transmitted.

The tuner/descrambler 11 performs processing (channel selection processing) that extracts signals for a reception channel set at present from television broadcast signals transmitted from the outside, predetermined high-frequency processing, scramble recall processing and demodulation processing. Signals obtained by performing these types of processing are fed out as a packet to the DEMUX circuit 12. The “reception channel” can be switched by the system controller 26.

The DEMUX circuit 12 decodes the packets received from the tuner/descrambler 11. Here, in the DEMUX circuit 12, the packets are classified into MPEG data indicating the content of a television program and additional information. Then, the MPEG data is fed out to the AV decoder 13, and the additional information is fed out to the system controller 26. The additional information is information on, for example, program information (including an identifier (hereinafter also referred to a program ID) unique to a program and a program name) about a television program that is currently being broadcast or is scheduled to be broadcast in the future, an electronic program guide (EPG), a notice from a broadcaster and the like, and is broadcast at predetermined intervals together with information on the content of the television program.

The additional information is described in SI/PSI in the case of ISDB (integrated services digital broadcasting) or is described in PSIP in the case of ATSC (advanced television systems committee).

The AV decoder 13 decodes the MPEG data received from the DEMUX circuit 12 into video signals and sound signals, and feeds the video signals and the sound signals to the input switching circuit 15.

The signal processing circuit 14 acquires, based on external reproduction signals received from the outside, the video signals and the sound signals indicating the content of reproduction (content). The signal processing circuit 14 feeds the video signals and the sound signals acquired out to the input switching circuit 15.

The input switching circuit 15 sets one of the television broadcast signal and the eternal reproduction signal to an input target. Then, the input switching circuit 15 transmits, only signals of the video signals and the sound signals transmitted from the side of the preceding stage that correspond to the input target at present, to a circuit on the side of the succeeding stage.

In other words, when the television broadcast signal is set to the input target, the input switching circuit 15 transmits the video signals and the sound signals transmitted from the AV decoder 13 to the video processing circuit 16 and the sound processing circuit 21, respectively. On the other hand, when the external reproduction signal is set to the input target, the input switching circuit 15 transmits the video signals and the sound signals transmitted from the signal processing circuit 14 to the video processing circuit 16 and the sound processing circuit 21, respectively. The input target can be switched by the system controller 26.

The video processing circuit 16 performs various types of processing on the video signals received from the input switching circuit 15, and feeds them out to the scaler 17. The processing performed by the video processing circuit 16 includes processing (for example, contrast adjustment, brightness adjustment and sharpness adjustment) for various types of image quality adjustments.

The scaler 17 performs, according to an instruction from the system controller 26, on the video signal, processing for displaying the video as a small screen (small screen display processing), and feeds it out to the combination circuit 18.

The combination circuit 18 receives video signals from the scaler 17, OSD signals (signals indicting an OSD display screen) from the OSD display circuit 28 and video signals on net content from the Internet processing circuit 29, and produces display signals indicting content obtained by combining (superimposing) the display content of these signals. The display signals are fed out to the video output circuit 19.

The video output circuit 19 feeds the received display signals out to the display 20 such that the content of the display signals is displayed on the display 20. As the display 20, for example, various displays such as a CRT (cathode ray tube) and a liquid crystal display can be used.

The sound processing circuit 21 performs necessary predetermined processing on the sound signals received from the input switching circuit 15, and feeds them out to the sound output circuit 22. The sound output circuit 22 feeds the received sound signals out to the speaker 23 such that sound indicated by the sound signals is output.

The remote control transmitter 24 is an operation means that is used to remotely operate the television receiver 1. The remote control transmitter 24 has various types of push button-type operation keys, produces remote control signals indicating the content of the operation corresponding to the operation key and wirelessly transmits them to the side of the main body of the television receiver 1. The side of the main body of the television receiver 1 receives the remote control signals through the remote control light receptor 25, and transmits information on the content of the operation to the system controller 26. In addition to the remote control transmitter 24, a plurality of types of operation keys (not shown) attached to the side of the main body are provided as the operation means of the television receiver 1.

The operation means described above are provided, and thus the television receiver 1 can reflect the operation of the user (the intension of the user) on the various types of operations. As the types of operation keys provided on the remote control transmitter 24 and the side of the main body, an “input switching (INPUT)” key, a “channel +” key, a “channel −” key, a “menu (MENU)” key, numerical keys (“0” to “9”), selection keys (“upper”, “lower”, “right”, “left” and “ENTER”), an “Internet (NET@)” key, red, green, yellow and blue color keys (“R”, “G”, “Y” and “B”), a “recall (RECALL)” key, an “exit (EXIT)” key and the like are prepared.

The “input switching” key is an operation key for switching the input target described above. The “channel +” key is an operation key for switching the reception channel described above in ascending order; the “channel −” key is an operation key for switching the reception channel in descending order. The “menu” key is an operation key for alternately switching the operation mode of the television receiver 1 between a normal mode and a menu mode.

The system controller 26 controls the individual portions of the television receiver 1 such that the television receiver 1 is properly operated. The details of the operation of the television receiver 1 will be described later.

The memory 27 stores information on various types of OSD display screens (screens for producing the OSD display on the display 2) and the like. As the OSD display screens, a menu screen, a mini-menu screen, an image quality adjustment screen of various types of items, a sound quality adjustment screen of various types of items, a help screen of various types of items and the like are prepared as previously fixed screens, and individual pieces of information on them are stored in the memory 27.

The OSD display circuit 28 receives OSD control signals (including the information on the OSD display screen) from the system controller 26, produces, based on the signals, the OSD signals indicting the OSD display screen and feeds them out to the combination circuit 18. Thus, the OSD display screen is OSD-displayed on the display 20. The system controller 26 reads the information on the OSD display screen from the memory 27 to produce the OSD control signals, and feeds them out to the OSD display circuit 28, with the result that the OSD display screen is OSD-displayed on the display 20.

The Internet processing circuit 29 functions to connect to the Internet 30, receives the provision of net content from a predetermined server through the Internet 30, feeds the video signals of the net content out to the combination circuit 18 and feeds the sound signals of the net content to the sound output circuit 22.

The Internet processing circuit 29 performs, according to an instruction from the system controller 26, processing (small screen display processing such as a ticker system) for displaying the net content as a small screen, and feeds it out to the combination circuit 18. The small screen display processing includes processing for displaying information on part of the net content in a predetermined position.

The communication IF (interface) 31 performs short-range communication with the portable information terminal 2. As a means of the short-range communication, Bluetooth that is standardized as IEEE802.15.1 by the IEEE or the like can be used. In this case, a PAN (personal area network) developed for establishing a wireless network between devices is implemented in the system controller 26 and the portable information terminals 2 and 3. The system controller 26 feeds communication control signals and communication data (for example, specified program information) out to the communication IF 31 by a protocol corresponding to its profile, and the communication IF 31 transmits the communication data while performing a handshake with the portable information terminal 2 within a range of short-range communication.

Examples of the portable information terminals 2 and 3 include smartphones, various types of mobile phones, portable game machines and PDAs (personal digital assistant). FIG. 2 is a plan view of an example of the portable information terminals 2 and 3. The portable information terminals 2 and 3 include a touch panel display 40, a key operation portion 41 that is formed with various types of push button-type operation keys, an LED display portion 42, a memory that stores the programs of the information exchange system, program information, comments and the like, a GPS portion (present location acquisition portion) that acquires positional information on the present location, a timer portion and the communication IF through which the short-range communication is performed.

The user who has purchased the television receiver 1 downloads and utilizes applications for the portable information terminals 2 and 3 from the Internet. At the time of manufacturing, the applications for the portable information terminals 2 and 3 may be stored in the television receiver 1, and the user who has purchased the television receiver 1 may acquire the applications from the television receiver 1.

The portable information terminal 2 acquires and stores the program information (communication data) from the television receiver 1, associates a comment (an opinion or an evaluation) of the user with the acquired program information and receives the input of the comment. Then, the portable information terminal 2 exchanges the comment (and also the program information as necessary) with another portable information terminal 3 that comes into the range of the short-range communication, acquires the place where the comment is exchanged with the other portable information terminal 3, associates it with the exchanged comment and stores it.

The short-range communication includes a case where the portable information terminals 2 and 3 directly communicate with each other and a case where they indirectly communicate with each other through a relay point (not shown) arranged in town. In the case of the intervention of the relay point, the communication data is temporarily stored in the relay point, and thus it is possible to perform transmission and reception with a time lag. The positional information may be acquired from the relay point; in this case, the portable information terminals 2 and 3 may not include the GPS portion. For the short-range communication between the portable information terminals 2 and 3, it is possible to use Bluetooth, Wi-Fi, a 3G function or the like.

The details of the main operation of the information exchange system will now be described. The main operation of the television receiver 1 will first be described. The television receiver 1 continuously receives, as a basic operation (an operation in the normal mode), the input target at present and content signals corresponding to the reception channel, and performs, in real time, a video display (the display of the content) and a sound output on the received content signals.

When the “input switching” key is operated, the system controller 26 receives it, and switches the input target. When the “channel +” key or the “channel −” key is operated, the system controller 26 receives it and switches the reception channel. By inputting a 1 to 4-digit channel number with the numerical keys (“0” to “9”), it is also possible to directly switch the reception channel to the channel of such a number.

When as described above, the input target or the reception channel is switched, the content signal to be received is switched, and thereafter the video and sound of new content signals after the switching are output. In other words, the display content to be displayed on the display 20 is switched.

The system controller 26 generates, based on the additional information and the like obtained by the reception, the OSD control signals indicating the OSD display screen such as the title, the guide and the like of the television program, and thereby can display them on the display 20.

When in the normal mode, the “menu” key is operated, the operation mode of the television receiver 1 is transferred to the menu mode in which the menu screen is displayed. On the other hand, when in the menu mode, the “menu” key is operated, the operation mode of the television receiver 1 is transferred to the normal mode.

FIG. 3 is an example of the menu screen. FIG. 3 shows a state where an item “program-related” on the menu screen is selected, and a cursor is placed on an item “program information output” among lower items displayed subsequently.

An operation related to information exchange will now be described. FIG. 4 is a flowchart showing an operation of the television receiver 1 on the information exchange. In a state where the user is viewing the television receiver 1, when the television receiver 1 is in the normal mode, and the user wants to exchange information such as feedback with another user on the program, the “menu” key of the remote control transmitter 24 is first operated.

Accordingly, in step 10, the television receiver 1 detects that the “menu” key is operated, and proceeds to step S11 where the menu screen is displayed. Then, the television receiver 1 proceeds to step S12 where whether or not the “program information output” shown in FIG. 3 on the menu screen is selected is determined.

When in step S12, the “program information output” is selected, the television receiver 1 proceeds to step S13 where the program information (including at least the program ID and the program name) is extracted from the additional information on the program (in other words, the specified program) being viewed. Then, the television receiver I proceeds to step S13 where the program information is transmitted through the communication IF 31 to the portable information terminal 2 within the range of the short-range communication and the processing is completed . Here, information that the transmission is completed is displayed on the display 20, and thereafter, the screen is switched to the screen of the program being viewed.

FIG. 5 is a flowchart showing an operation of the portable information terminal 2 on the information exchange. In step S20, the portable information terminal 2 receives and stores the program information from the television receiver 1. Then, when in step S21, an instruction to start up an application of the information exchange system is provided by the operation of the user, the portable information terminal 2 proceeds to step S22 where as shown in FIG. 6, an input screen 50 for the comment associated with the acquired program information is displayed, and an input is received. The comment includes the opinion and evaluation (overall evaluation) of the user, and in the present embodiment, further includes the impression of the user.

The screen 50 of FIG. 6 is formed with a program name 51 to which the comment is input, a button 52 for switching to the program name of another piece of program information acquired, an entry field 53 to which a though or an opinion is input, an entry field 54 to which an impression is input, an entry field 55 to which an overall evaluation is input, an input completion button 56, a home button 57, a thought/opinion button 58, a communication condition button 59, a collection result button 60, a communication history button 61 and a TV synchronization button 62.

When the thought/opinion button 58 is operated, the cursor is displayed in the entry field 53, and thus it is possible to input characters. Then, the user inputs their opinion and though on the program. When in this state, the entry field 54 is operated, a popup screen 63 as shown in FIG. 7 is superimposed and displayed, and thus it is possible to select any of the impressions. In the state of FIGS. 6, 1 to 5 (poor to satisfactory) in the entry field 55 are operated, and thus it is possible to select the overall evaluation from the five steps. FIG. 6 shows a state where the evaluation of 5 is selected.

The operation of the portable information terminal 2 will be described again. The process proceeds from step 22 to step S23 where whether or not the input completion button is operated is determined. When in step S23, the inputs to the individual fields are completed, and the input completion button is operated, the process proceeds to step S24 where the details input are stored in the memory.

FIG. 8 is a flowchart showing an operation between the portable information terminals 2 and 3 on the information exchange. When the portable information terminal 2 is carried in town, in step S30, the portable information terminal 2 determines whether or not the other portable information terminal 3 comes into the range of the short-range communication. Her; it is assumed that the other portable information terminal also installs the application of the same information exchange system.

In a case where in step S30, the other portable information terminal 3 comes into the range of the short-range communication, such as a case where the users pass each other in town, the process proceeds to step S31 where the communication with the other portable information terminal 3 is established, the program IDs stored in the portable information terminals 2 and 3 are exchanged and comparison is performed to see if the same program ID is present.

If the same program ID is present, the process proceeds to step S32 where the comments with which the same program ID is associated and which are stored in the portable information terminals 2 and 3 are exchanged by data communication. Here, the place and the date and time on which the comment is exchanged with the other portable information terminal 3 are also acquired, are associated with the exchanged comments and are stored. When the comment which has already been associated with the same program ID by information exchange with yet another portable information terminal is acquired, such a comment is also exchanged.

When the exchange of the comments is completed, the process proceeds to step S33 where the portable information terminal 2 notifies information that the comments are exchanged. A method of the notification is preferably to blink the LED display portion 42 or to display a message on the touch panel display 40.

On the other hand, if in step S31, the same ID is not present, the processing is completed. Thus, the comment on the program of no interest is prevented from being acquired. It is not always necessary to perform step S31, and thus step S31 may be omitted, and the process may proceed from step S30 to step S32. In this case, all the comments and program names stored in the portable information terminals 2 and 3 are preferably exchanged. On the program, among the acquired comments, that the user of the present portable information terminal has not seen, it is easy to identify it by displaying the comment and the program name in a different color. This can be determined by whether or not the present portable information terminal has the program ID associated with the received comment.

Then, when the user notices the notification to perform an operation of displaying the comment, as shown in FIG. 9, a list screen 70 on the comments of the program whose information has been exchanged is displayed. On the list screen 70, new icons 72 indicating that person A and person B newly receive comments are added. The date and time and the place on which the reception is performed are added to each of the comments. The list screen 70 is also displayed when the home button 57 is operated.

When on the screens of FIGS. 6 and 9, the collection result button 60 is operated, a collection result screen 80 as shown in FIG. 10 is displayed. For each of the programs whose information has been exchanged, the collection result screen 80 is formed with the number and bar graph of people in the five-step overall evaluation and the circle graph of the impression. Thus, the evaluations of the other users on the programs are found at a glance. The collection result is calculated based on comments acquired by the portable information terminal 2.

When the communication history button 61 is operated, for example, the history of information exchange with the other portable information terminal is displayed in one line. As the history, the date and time when the information exchange is performed, the user name, the program name and the like are displayed as necessary in reverse chronological order of reception.

When the communication condition button 59 is operated, a screen (not shown) for setting conditions is displayed as to what type of portable information terminal the information exchange is performed with, and this allows the user to set each of the conditions. As the conditions, for example, the profile (such as the age group, the sex and the residential area) of the user and the idea (such as the genre of the program) can be preferably selected. When these conditions are set, the information exchange is performed with only the portable information terminals that satisfy the conditions.

When the TV synchronization button 62 is operated or when terminal synchronization is selected on the menu screen of the television receiver 1, the screens that are currently displayed by the portable information terminal 2 and that are shown in FIGS. 6, 7, 9 and 10 are transmitted to the television receiver 1, and the screens are displayed on the television receiver 1. Thus, it is possible to produce a display on a large screen, and in particular, the screen on the collection result or the like is easily seen.

When in the present invention, the television receiver has a recording function, the program ID and the program name are stored at the time of recording, and thus it is possible to output the program information from the menus screen at the time of reproduction. When the information exchange is desired to be performed on a program in the past whose information the portable information terminal 2 has not acquired from the television receiver 1, the information exchange can be performed by acquiring the program information in the past with the portable information terminal 2 from the Internet 30. When the information exchange is desired to be performed on a program in the future, the information exchange can be performed by utilizing EPG with the television receiver 1 to acquire the program information.

In the present invention, the exchange of the program information may be performed for only a predetermined period such as one week. In this case, out-of-date program information may be automatically deleted.

### LIST OF REFERENCE SYMBOLS

1 television receiver
2, 3 portable information terminal

1. An information exchange system that includes a television receiver and a portable information terminal which performs short-range communication with the television receiver and another portable information terminal,
wherein the television receiver acquires, from a broadcast wave, program information including an identifier and a program name of a specified program, and transmits the program information to the portable information terminal within a range of the short-range communication, and
the portable information terminal acquires the program information from the television receiver, associates a comment with the acquired program information to receive an input of the comment and exchanges the comment with another portable information terminal which comes into the range of the short-range communication.

2. The information exchange system of claim 1,
wherein the portable information terminal compares the identifiers with the another portable information terminal which comes into the range of the short-range communication, and exchanges a comment which is associated with the same identifier.

3. The information exchange system of claim 1,
wherein the comment includes an opinion and an evaluation of a user,
the portable information terminal collects the evaluations and
the portable information terminal or the television receiver displays a collection result of the evaluations.

4. The information exchange system of claim 1,
wherein the portable information terminal can set a condition under which the short-range communication is performed with the another portable information terminal.

5. The information exchange system of claim 4,
wherein the condition under which the short-range communication is performed includes profile information on the user.

6. The information exchange system of claim 1,
wherein the portable information terminal includes a present location acquisition portion that acquires positional information on a present location, acquires a place where the comment is exchanged with the another portable information terminal and associates the place with the exchanged comment.

7. The information exchange system of claim 1,
wherein when the comment is exchanged, the portable information terminal notifies information that the comment is exchanged.

8. A television receiver that performs short-range communication with a portable information terminal,
wherein the television receiver acquires, from a broadcast wave, program information including an identifier and a program name of a specified program, and transmits the program information to the portable information terminal within a range of the short-range communication.

9. The television receiver of claim 8,
wherein the television receiver acquires a comment associated with the program information from the portable information terminal, and displays the comment.

10. A portable information terminal that performs short-range communication with a television receiver or another portable information terminal,
wherein the portable information terminal acquires program information including an identifier and a program name of a program from the television receiver, associates a comment with the acquired program information to receive an input of the comment and exchanges the comment with another portable information terminal which comes into a range of the short-range communication.

11. The portable information terminal of claim 10,
wherein the portable information terminal compares the identifiers with the another portable information terminal which comes into the range of the short-range communication, and exchanges a comment which is associated with the same identifier.

12. The portable information terminal of claim 10,
wherein the comment includes an opinion and an evaluation of a user,
the portable information terminal collects the evaluations and displays a collection result of the evaluations.

13. The portable information terminal of claim 10,
wherein the portable information terminal can set a condition under which the short-range communication is performed with the another portable information terminal.

14. The portable information terminal of claim 13,
wherein the condition under which the short-range communication is performed includes profile information on the user.

15. The portable information terminal of claim 10,
wherein the portable information terminal includes a present location acquisition portion that acquires positional information on a present location, acquires a place where the comment is exchanged with the another portable information terminal and associates the place with the exchanged comment.

16. The portable information terminal of claim 10,
wherein when the comment is exchanged, the portable information terminal notifies information that the comment is exchanged.
